(19) United States
(12) Patent Application Publication
(10) Pub. No.: US 2005/0024569 A1
(43) Pub. Date: Feb. 3, 2005

(54) Liquid crystal device for the space modulation of light with active matrix structured counter-electrodes, corresponding applications and method of design

(75) Inventors: Philippe Gravey, Lannion (FR); Bruno Vinouze, Penvenan (FR)

Correspondence Address: MERCHANT & GOULD PC, P.O. BOX 2903, MINNEAPOLIS, MN, 55402-0903, US

(73) Assignees: OPTOGONE, Plouzane (FR); Ecole Nationale Superiure des Telecommunications de Bretagne, Brest Cedex (FR)

(21) Appl. No.: 10/760,743

(22) Filed: Jan. 20, 2004

(30) Foreign Application Priority Data
Jan. 20, 2003 (FR) 03 00596

(51) Int. Cl. G02F 1/1343

(52) U.S. Cl. 349/139

(57) ABSTRACT

Liquid crystal device for the space modulation of light having at least one control electrode structured in the form of a first active matrix defining a plurality of first elementary zones, and at least one counter-electrode which is structured in the form of a second active matrix defining a plurality of second elementary zones. Also disclosed is a method of liquid crystal space modulation of light.

The field of the invention is that of optical telecommunications, optical signal processing and visualisation.

More precisely, the invention relates to a liquid crystal device for the space modulation of fast light and to its method of design.

Such a device notably applies, but not exclusively, to visualisation applications of large alpha-graphic displays used outside, to beam deflexion for optical fibre communication in open space, or to optic interconnection.

The usage of liquid crystals is widespread for the making of display devices, in which a set of voltages of adjustable values is applied to different elementary zones of a liquid crystal cell. According to the required optical architecture, such a cell is normally constituted of a thickness of a few microns of a liquid crystal type material confined between two glass plates or of a substrate and on which are placed conductive electrodes which are therefore, either transparent, or non-transparent. In this type of architecture, the displaying of optical information is obtained by exploiting variations in certain optical properties of the liquid crystal depending on the value of the voltage or electric field which is applied to it. By way of illustrative example, concerning the usage of a twisted nematic (TN) liquid crystal, the optical effect used is the variation in the polarisation of the light when passing through the device, depending on the voltage applied to the terminals of the liquid crystal. Thus the usage of this electro-optic effect in a polariser will result in the displaying of black, white or even different shades of grey. More generally, a large variety of electro-optic configurations and of liquid crystals can be used in the making of light space modulators, whether they are dedicated to visualisation, the optical processing of information or to optical fibre communication.

According to a technique known in the prior art, one of the electrodes of the device serves to delimit the elementary zones (or pixels) of the cell which can be addressed independently. This delimiting is made via an appropriate etching of the conductors. A control electrode moreover allows the voltages applied to these conductors to be controlled. Generally, a second electrode, or counter-electrode, is used to set a voltage reference on the opposite side of the crystal. FIG. 1 illustrates a standard display unit with seven segments in transmissive mode, of liquid crystal cell type. Such a cell generally comprises an etched electrode 11 comprising seven segments 12 constituted of indium oxide and tin (ITO), a counter-electrode 13, a thickness of a liquid crystal 14 between the electrode 11 and the counter-electrode 13, as well as a voltage generator 15. In this way, as long as an electric current voltage is applied to all or some of the ITO segments 12 of the etched electrode 11, a clear display 17 is obtained by applying backlighting 16.

The choice of a specific liquid crystal technology is made according to criteria specific to each application. Among the criteria, the response time of the electro-optic effect is a parameter often considered to be essential.

In the particular case of nematic liquid crystals, which are by far the most widespread in industry, two response times are identified.

The first response time, known as rise time, is measured when passing from a zero voltage applied to the liquid crystal terminals, to a voltage greater than the threshold voltage, from which an electro-optic effect is observed. According to a method of calculation known in the prior art, the value of this rise time is, for a voltage sufficiently high in relation to the threshold, proportional to the square of the thickness of liquid crystal and to the inverse of the applied voltage. Thus, the higher the voltage value, the faster the rise time is, and vice versa. By means of example, for a parallel alignment nematic liquid crystal cell, the rise time is measured at 700 ms for an applied voltage of 0.5 V, compared to 20 ms when this applied voltage is 5 V.

Conversely, the second response time, known as fall time, is observed when the voltage at the liquid crystal terminals is abruptly brought back to zero. Still according to a method of calculation known in the prior art, the fall time corresponds at first approximation to the square of the thickness of liquid crystal. It does not, moreover, depend on the voltages. Thus, in the case of a parallel alignment cell, a fall time of 180 ms is measured for a thickness of liquid crystal of 8 μm, compared to 100 ms for a thickness of liquid crystal of 5 μm.

Different technological solutions aimed at resolving the problem of optimising the response times of liquid crystals in display devices have been proposed. Generally speaking, they are compatible with display frequencies of the order of several tens of Hertz (typically 60 Hz) necessary for comfortable visualisation.

However, the maximum response time values acceptable for applications in the telecommunications field generally depend on the application in question, and more precisely, on the function performed by the liquid crystal device and on the context in which it is used. For example, in the case of using such liquid crystal devices in an optic channel cross-connect system, notably dedicated to the re-routing of these channels in breakdown situations of some of the associated transmission systems, the required response time must not be greater than a fraction of the total time needed for the calculation of the new connections to be made. Thus, in compliance with the demands of the different telecommunication operators and in coherence with current knowledge of routing algorithms, this response time is considered as substantially less than 50 ms.

Now, in the case of using nematic type liquid crystals for such devices of an optic channel cross-connect system, the objective of optimising the response time, which must be substantially less than the pre-set threshold of 50 ms, is very difficult to attain.

Indeed, in the case of using a nematic liquid crystal in the field of telecommunications, the operating wave length goes from visible (around 0.5 μm) to infrared (around 1.55 μ). A possible solution to obtain an optical effect sufficient to carry out a processing of information, can consist in increasing the thickness of the liquid crystal in a proportion substantially equal to the operating wavelength. Indeed, the birefringence of the liquid crystal decreases with the operating wavelength. Now, according to the aforementioned method of calculation, regarding the obtaining of the fall time, the greater the thickness of liquid crystal, the greater the value of this fall time. Moreover, the increase in the thickness of the liquid crystal will have a negative effect on the value of the rise time, thus requiring the application of a higher voltage to the liquid crystal terminals so as to maintain the value of the rise time. The compensation for such an increase in the thickness of the liquid crystal thus resides in the major increase in the global response time of the device, an increase contrary to the desired objective.

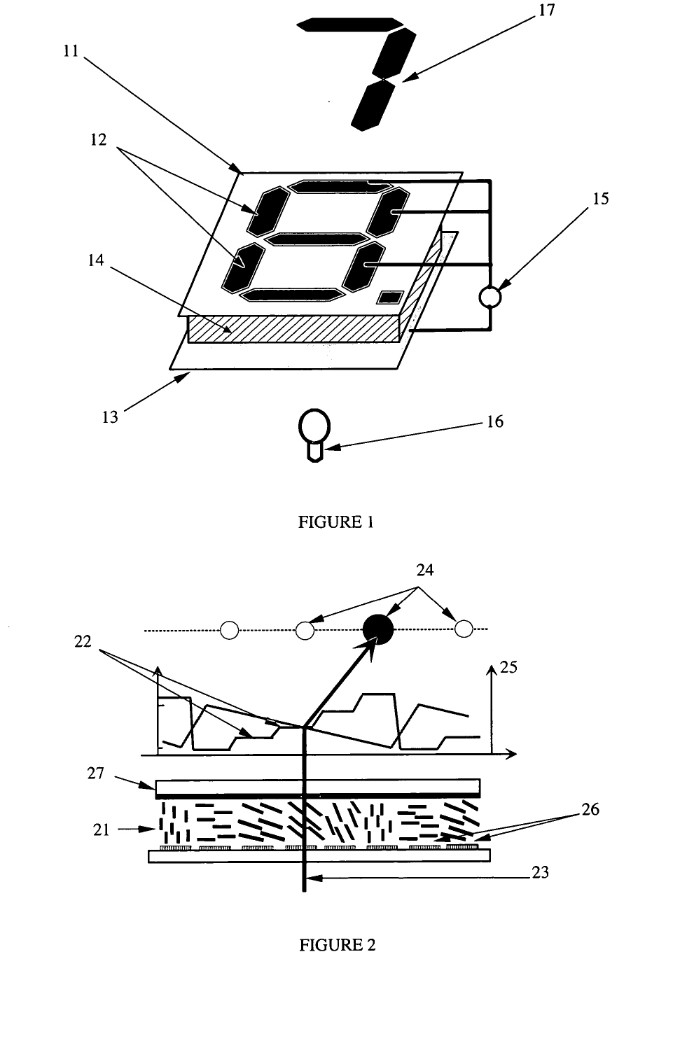

As is illustrated in FIG. 2, in the case of using a nematic liquid crystal 21 to engender blazed gratings 22 to deviate a beam 23 derived from an optical fibre, the increase in the thickness of liquid crystal 21 is also penalising. Indeed these blazed gratings also need, via the electrodes 26 and/or the counter-electrode 27, the application, on part of the elementary zones (pixels), of a voltage 25 close to the pre-set threshold, this constraint then contributing to the worsening of the global response time of the device. By means of example, for a diffraction cell whose network step is made up of six consecutive electrodes to which are applied voltages of 0 V, 1.55 V, 1.58 V, 1.89 V, 2.2 V and 3.2 V, response times of 20 seconds to completely establish the diffraction network are recorded, the associated fall time being then 150 ms.

A known and proposed technical solution, also due to the large number of cells to be addressed, consists in using active matrix addressing.

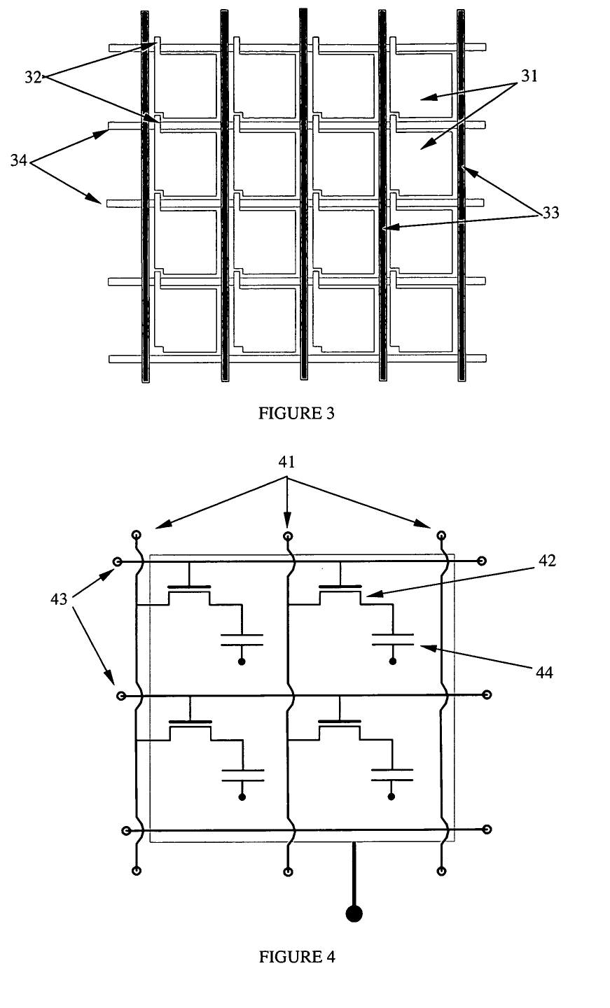

FIG. 3 illustrates an active matrix composed of pixels 31 addressed via thin film transistors (TFT) 32 by a matrix of columns 33 and lines 34. FIG. 4 shows the equivalent electrical diagram of the active matrix in FIG. 3. According to this diagram, the voltage applied to the nematic liquid crystal is an alternating voltage, this material only reacting to the correct voltage applied to it. The addressing of the pixels of such a matrix is sequentially carried out line by line, according to the following process. The voltages are applied to the columns 41 via specific circuits. The transistors 42 of a line 43 are rendered passing by applying a positive voltage solely to this line. The voltage of a column is transferred to the pixel 44 located at the intersection of the column 41 and of the positive line 43, via its transistor 42. Then, the thin film transistor is rendered blocking by applying a negative voltage to the line 43. The process is then repeated line by line. We call “field duration”, the time needed for the addressing of all the lines and “line duration” the time needed for the addressing of one line.

There are two techniques known in the prior art for generating an alternating voltage.

In a first technique, called constant alternate counter-electrode mode, the counter-electrode is kept at a fixed reference potential (for example the mass) and the electrode sees its potential alternating between two voltages that are symmetrical to the reference voltage. With a symmetrical square waveform, the correct voltage is then equal to half of the peak-peak voltage.

In a second technique, called alternate counter-electrode mode, the alternating voltages are applied to the electrode and to the counter-electrode, but in phase opposition. A particular benefit of the alternate counter-electrode mode is that it allows the same correct voltage to be delivered as the constant alternate counter-electrode mode, with a maximum voltage equal to half the voltage needed in the first configuration. In the specific case of an active matrix, the alternate mode is produced either at the field frequency or at the line frequency.

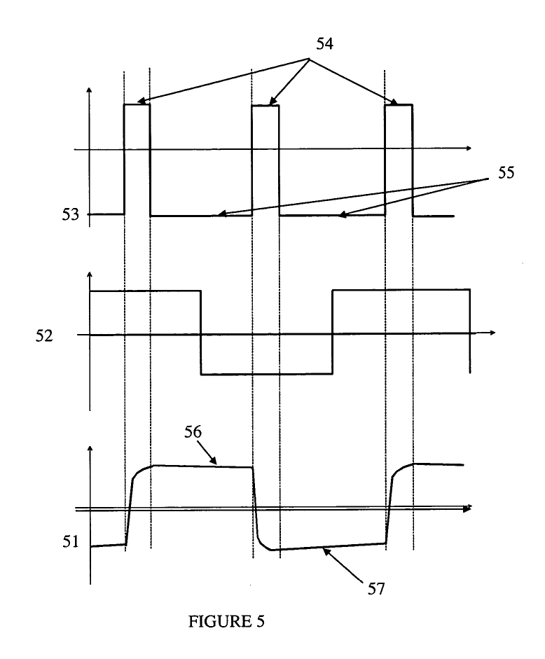

FIG. 5 illustrates the chronogram of the operating voltages of a simple active matrix of 625 lines in video mode. In this particular case, a pixel 51 takes the potential of its column 52 when the line 53 renders the TFT passing 54. Then a negative voltage 55 on the line blocks the TFT, the charge being maintained at the terminals of the pixel, as far as the following alternate mode 54 (not accounting for the loss of liquid crystal). The new applied voltage 57 is, in this case, inverse of the previous voltage 56. The chronogram in FIG. 5 shows an alternate mode column at the field frequency which allows a correct voltage equal to half the peak column voltage, that being typically 5 Veff, to be delivered at the terminals of an elementary zone (or pixel). Furthermore, specific integrated circuits or drivers are connected to the lines and to the columns of the active matrices whose line voltages vary from −5 V to +15 V and the column voltages from −5 V to +5 V.

If the voltage of the counter-electrode is in phase opposition in relation to the column voltage and alternating, for example, at the line frequency, then the correct voltage at the liquid crystal terminals will be doubled, possibly reaching 10 Veff. These values are typical of active matrices of TFTs on glass.

Moreover, in the particular case of using liquid crystal on silicon (LCOS), the voltages applicable to the elementary zones, or pixels, are of the order of 5 V or of 3.3 V, depending on the circuit technology used.

The technology for addressing such unique active matrices, according to the prior art, thus clearly shows that it is not possible to deliver voltage pulses of 15 to 20 V Veff needed to obtain short response times. This is all the more true for the LCOS whose integrated circuit on silicon technology limits the useful voltages to only 5 V.

Several known techniques aimed at resolving these constraints of diminishing or optimising response times have been carefully designed and proposed.

A first technique consists in using a liquid crystal cell in reflection, when the optical architecture allows for it. The thickness of the liquid crystal is thus divided by two, resulting in a dividing by four of the rise and fall times. The principal inconvenience of this technique resides in the fact that all the applications do not allow such a cell in reflection to be used.

A second technique consists in optimising the composition of the liquid crystal itself. Indeed, it is possible for a manufacturer of liquid crystals to play around with parameters as varied as the viscosity, the optical anisotropy, or even the dielectric anisotropy. The principal inconvenience of this approach resides in the fact that the modifications made to these parameters generally result in developments contrary to the objectives of display and/or optimising of the response times. For example, the increasing of the optical anisotropy phenomena is generally created by using chlorinated or fluorinated molecules. Now, the latter have viscosities higher than the cyano-biphenyl molecules that are usually used, with the compensation of a small reduction in the response time.

A third technique dedicated to the improvement of the temporal response of a nematic liquid crystal cell consists in applying a brief pulse (a few milliseconds) of high voltage. It is based on the transitory nematic effect. To be more precise, the initial application of a high voltage, common to all the elementary zones (or pixels) of an active matrix of an electrode, allows the liquid crystal molecules to be displaced more quickly. After a few milliseconds, this first pulse voltage is then replaced by other voltages continually applied to the electrode. Thus, the liquid crystal molecules reach their balance point much quicker than with a standard addressing. The implementing of this approach, in the case of a nematic liquid crystal beam deflector, has been thoroughly studied by A. Tan and his team in the article entitled “Improvement of response time of electrically addressed nematic crystal blazed gratings” published in 2000, in the proceedings of the conference “Optics in computing” (Vol. 4089, pp 208-218). In this article, a blazed grating is addressed according to the standard voltages (6 consecutive electrodes at respectively 0.9 V, 1.62 V, 1.88 V, 2.35 V, 3.15 V and 5 V). It has a rise time of 190 ms if no pulse is applied. The same cell, however, has a rise time of only 40 ms when a pulse of 10 V is applied to it for 6 ms. This technique therefore results in a gaining of 4.5. Furthermore, it has been shown that the pulse technique becomes truly efficient when the value of the provisional pulse voltage reaches 3 to 4 times the normal addressing voltage (that being a pulse of 15 to 20 V). This voltage is applied by means of the control electrode. Electrode addressing has the main advantage of procuring a high flexibility of addressing. Indeed, generally speaking, voltage pulses can be applied to any group of elementary zones (or pixels) However, it requires the insertion of these voltage pulses directly within the control signals of the pixels and therefore imposes as compensation a terminal higher than the value of this transitory voltage, due to the characteristics of the components used in the control electrode. By way of example, when this electrode comprises an integrated circuit on silicon, the maximum voltage is of 5, 3.3 or 2.5 Volts, depending on the technology of the integrated circuit. An inconvenience of this electrode addressing technology comes from the fact that the limitation of the maximum authorised voltage does not allow to apply a sufficient voltage pulse necessary for the optimising of the response time.

An alternative known in the prior art to the applying of a voltage pulse via the electrode consists in using the counter-electrode to overcome the aforementioned constraint, but at the detriment of the flexibility of addressing. Indeed, it is possible to isolate via etching the different parts of the counter-electrode, each linked to an independent voltage supply, as disclosed in the article by A. Lelah and his team entitled “A CMOS VLSI Pilot and Support Chip for a Liquid Crystal on Silicon 8×8 Optical Cross-Connect” published in 2001 in the proceedings of the conference “SPIE: Wave Optics and VLSI Photonic Devices for Information Processing” (Vol. 4435, pp. 173-183). However, this approach is only possible for zones to which electric access is simple, the objective being to generate one voltage pulse per etched zone. The main inconvenience of this technique resides in the fact that it adapts with difficulty to the structures of high-definition modulators, in particular two-dimensional space modulators, the most commonly used today. Indeed, the paths allowing access to the etched zones on the counter-electrode constitute lost surface for the electro-optic effect. This technique is notably incompatible with the high-definition reflective circuits of LCOS type.

To this day, we do not know, in the prior art, of a particular structure of liquid crystal space modulators of light, nor of a specific intrinsic electric addressing technique to such a modulator, which would allow to optimise the response times without altering in whatsoever manner the desired electro-optic effect(s).

The purpose of the invention is notably to overcome these main inconveniences of the prior art.

More precisely, an objective of the invention is to provide a space modulation device of light that can offer reduced response times (preferably in a ratio of at least four), compared to the techniques and technology known in the prior art, without altering the desired electro-optic effect.

Another objective of the invention is to provide such a device in liquid crystal cell structure, which can be used in reflection.

An additional objective of the invention is to provide such a device that does not need a variation in the thickness of the film of liquid crystal used to obtain a good compromise: response time to desired electro-optic effect.

Yet another objective of the invention is to provide such a device that does not need any prior modification to the parameters of the chosen liquid crystal.

An additional objective of the invention is to provide such a device with an electric addressing technique authorising at the same time the applying of a high voltage pulse that is not limited in maximum value and a flexibility in the addressing of the elementary zones (or pixels).

Finally, a last objective of the invention is to provide such a device that adapts well to the structure of high-definition modulators, in particular two-dimensional space modulators, and that is compatible with high-definition reflective circuits of LCOS type.

These objectives, as well as others which will appear later, are reached with the help of a liquid crystal space modulation device of light comprising at least one control electrode structured in the form of a first active matrix defining a plurality of first elementary zones, and at least one counter-electrode also structured in the form of a second active matrix defining a plurality of second elementary zones.

The general principle of the invention therefore consists in using in a liquid crystal cell playing the role of a space modulator of light, a control electrode structured in the form of an active matrix and a counter-electrode also structured in the form of an active matrix, both the latter having a plurality of elementary zones. Indeed, a standard counter-electrode with etched zones linked to the peripheral electronics by as many paths as there are etched zones, does not allow to use the maximum of the surface of the active matrix of the electrode.

Preferably, the device according to the invention comprises first means of applying an electric voltage pulse to said electrode and/or said counter-electrode. This type of counter-electrode allows a brief voltage pulse to be applied on part of the space modulator of light so as to shorten its response time, whilst ensuring the desired electro-optic effect. The double active matrix structure of the electrode and counter-electrode, according to the invention, allows a voltage pulse to be generated at the liquid crystal terminals. The voltage pulse has an amplitude much greater than the maximum voltage delivered by the addressing circuit of the electrode pixels. This pulse is applied via an active matrix of the counter-electrode. Thanks to this active matrix of the counter-electrode, the voltage pulse can be selectively applied according to only the pixels concerned with a change in state.

Advantageously, the means of applying a voltage pulse selectively apply the electric voltage pulse to a region defined by at least one of the elementary zones of the electrode and/or counter-electrode.

The use of an active matrix of the counter-electrode allows the brief electric voltage pulse to be applied locally, according to only the elementary zones (or pixels) concerned with a change in state. The peripheral electronics allows the elementary zone(s) of the counter-electrode(s) concerned with the passing of the optical beam to be defined. In a particular embodiment, the addressed elementary zone thus commutes in alternate counter-electrode mode and a maximum voltage can then be delivered via the connectors linking the peripheral addressing electronics with the columns of the active matrix of the counter-electrode. The elementary zones of the active matrix of the electrode corresponding to this interconnection are also brought to the maximum voltage that can be delivered, but in opposite phase compared to the voltage applied to the counter-electrode. The brief voltage pulse is for example applied for 5 to 10 milliseconds. Moreover, the voltages related to the diffraction networks are applied to the electrode whilst the counter-electrode goes back to fixed mode.

Preferably, the device according to the invention comprises means of selective addressing of at least some elementary zones of the electrode and of the counter-electrode. We thus benefit from an advantage of the active matrix structure of the counter-electrode which no longer requires the linking of each etched zone to the peripheral electronics by as many paths as there are etched zones, as in the case of standard counter-electrodes according to the prior art. Such a structure offers a double advantage, that being the possibility of using the maximum surface of the electrode and being able to electronically address in a selective manner each elementary zone of each active matrix.

Advantageously, the means of addressing are means of applying and of multiplexing control voltages, piloting the electrode and the counter-electrode. A peripheral electronics is directly connected to the active matrices of the electrode and of the counter-electrode and has the role of synchronising the voltages that are applied to them.

The operating of the device according to the invention is thus broken down into two distinct phases: the pulse phase which corresponds to the establishing of a new voltage and the stabilised operating phase which corresponds to the sustaining of voltages.

Advantageously, each of the elementary zones is associated with at least one control transistor. The counter-electrode structured as an active matrix with elementary zones each comprising at least one control transistor, advantageously allows a selective pulse to be applied to some elementary zones of the active matrix.

Preferably, the electrode and the counter-electrode are assembled facing each other in substantially parallel planes.

Advantageously, the liquid crystal is confined between the electrode and the counter-electrode.

Preferably, the liquid crystal belongs to the group comprising:
nematic type liquid crystals;
smectic type liquid crystals;
ferroelectric type liquid crystals;
cholesteric type liquid crystals.

Advantageously, the amplitude of the voltage pulse is substantially greater than the maximum voltage delivered by the means of selective addressing of the elementary zones of the electrode.

With the desired structure according to the invention, the operating is broken down into two operating phases: the pulse phase which corresponds to the establishing of a voltage pulse and the stabilised operating phase which corresponds to the sustaining of the voltages. In some particular cases, new pulse voltages can be applied via the electrode and the counter-electrode in alternate counter-electrode mode before applying the final control voltages. Furthermore, a loading of interconnections can have three phases: the erasing of the networks, the applying of a pulse, then the applying of the final voltages for the writing of new networks.

In the particular case of a device according to the invention bearing a double active matrix structure, the active matrix of the electrode being made according to the LCOS technology and the active matrix of the counter-electrode according to the TFT technology, the voltage pulse which can be applied is of two to ten times greater than that which could be applied if the two active matrices of the structure are of type TFT.

More precisely, if the active matrix of the LCOS electrode receives a maximum voltage of +5−5 Volts and the counter-electrode TFT a voltage of +30−30 Volts, the stabilised operating voltage will have a maximum of 5 Volts and the voltage pulse of 35 Volts.

Preferably, at least some of the second elementary zones have a surface and/or a shape different from the first elementary zones that are facing it.

The device allows a voltage pulse to be generated directly to the liquid crystal terminals. The device structure according to the invention seems to be the only one known to date which authorises the applying of a voltage pulse on a high-definition deflector, for example of LCOS type.

Advantageously, at least some of the second elementary zones have a surface greater than or equal to that of the first elementary zones that are facing it.

In a particular embodiment according to the invention, each elementary zone of the counter-electrode thus covers four elementary zones of the electrode. Each control transistor of minor thickness, equipping each elementary zone of the counter-electrode, is then sized so as to load the four elementary zones of the active matrix of the electrode.

Preferably, each elementary zone of the counter-electrode covers at least two elementary zones of the electrode.

The invention is well adapted to visualisation applications of large alpha-graphic displays used outside. This addressing technique allows the screen to keep the response times compatible with the video signals for variable temperature conditions. Indeed, it is known that low temperatures create an increase in the viscosity of the liquid crystals which results in an increase in the response time. In this case, an elementary zone (or pixel) of the counter-electrode covers three pixels of the electrode, the red, the green and the blue. The extra cost generated by this active matrix of the counter-electrode remains acceptable compared to the initial price of the very large screen.

Furthermore, in the case of a beam deflection application for open space optic commutation, the number of pixels needed to branch 100 optic beams is one million (1024×1024). Each beam is collimated by a micro-lens, then deflected by a portion of the space modulator of light comprising 10,000 pixels (100×100). In this case, the number of pixels of the counter-electrode must be at least 100 (10×10) and each pixel will serve to manage the entire surface encompassing the optic beam. It can however be advantageous to have a greater number of pixels on the counter-electrode so as to use the same space modulator of light in the different optic architectures. For example, with a number of counter-electrode pixels equal to 204×204 (that being 5 electrode pixels covered by a pixel of the counter-electrode) it becomes possible to structure the same space modulator of light into 144 zones of 85×85 pixels (17×17 counter-electrode pixels), 100 zones of 100×100 pixels (20×20 counter-electrode pixels) or 64 zones of 125×125 pixels (25×25 counter-electrode pixels). These approximations, given by means of example and non-restrictive, are compatible with the possibilities of active counter-electrode technology. Let us consider an electrode of LCOS technology which allows particularly small pixels (10 μm), in the computing format SXGA (1280×1024) to be obtained, which offers a cinema type result. In this case, as the electrode is reflective, the counter-electrode must therefore be transparent. It is necessary to use active matrix TFT technology. This allows a counter-electrode pixel size of 50 μm to be attained, that being equivalent to 5 control electrode pixels.

Preferably, an elementary zone of the counter-electrode is placed facing at least one elementary zone of the electrode.

The electrode and the counter-electrode are generally made on a glass or silicon substrate. Depending on the nature of the substrate thus used according to the retained optic architecture, the electrode can be transparent.

Advantageously, the electrode and the counter-electrode are made on at least one glass or silicon substrate plate.

Advantageously, the electrode and the counter-electrode have at least two orientation films of liquid crystal.

Compared to the prior art, the invention allows (at least divided by four) the response time of a high-definition space modulator of light to be reduced considerably. The structure of the invention allows a voltage pulse at the liquid crystal terminals to be generated. The voltage pulse has an amplitude much greater than the maximum voltage delivered by the addressing circuit of the electrode pixels. This pulse is applied via an active matrix of the counter-electrode. Thanks to this active matrix of the counter-electrode, the voltage pulse can be locally applied according to only the pixels concerned with a change in state. Thus, an addressing electronic synchronises the control signals applied to the active matrix of the electrode and to the active matrix of the counter-electrode. This structure seems to be the only one known to date which authorises the applying of a pulse on a high-definition deflector, for example of LCOS type, thanks to an active matrix of the counter-electrode. This counter-electrode has a large opening rate, which has the additional advantage of minimising the lost surface on the deflector.

The invention also relates to a method of liquid crystal space modulation of light comprising at least one control electrode structures in the form of a first active matrix comprising a plurality of elementary zones, and at least one counter-electrode, so as to define on the counter-electrode a plurality of elementary zones controlled by a second active matrix.

In the particular case of applying the invention to optic interconnection, during the reconfiguration of one or several interconnections, a voltage pulse can be applied to the liquid crystal via the elementary zones of the electrode and to the elementary zones corresponding to the counter-electrode.

In stabilised interconnection phase, it is possible to use the simplest addressing mode with alternating columns. In this case, all the elementary zones of the active matrix of the counter-electrode are brought to a fixed potential reference. The active matrix of the counter-electrode therefore acts as a practically unique conducting plane covering the entire surface of the matrix active of the electrode. The latter thus operates as a standard active matrix and ensures the management of the voltages at the terminals of each elementary zone of the electrode. The voltage is thus alternating on the columns once all the lines of the cell have been addressed.

Furthermore, when an interconnection must be established between two fibre optics, the management electronics defines the zone of the active matrix of the counter-electrode which is concerned with the passing of the optic beam. This zone commutes in alternate mode with counter-electrode and the system applies the maximum authorised voltage. The elementary zones of the active matrix of the counter-electrode corresponding to this interconnection are then brought to the maximum voltage that can be delivered and in opposite phase compared to the active matrix of the counter-electrode. This pulse is applied during 5 to 10 ms. Finally, the voltages which correspond to the diffraction network are applied to the active matrix of the electrode whilst the active matrix of the counter-electrode goes back to the fixed counter-electrode mode. Two phases are therefore necessary to establish a new optic interconnection: the application phase of a pulse, then the application phase of final voltages.

Advantageously, the method according to the invention comprises the successive stages of:

(c) applying a voltage pulse to at least one of said elementary zones of said counter-electrode;

(e) applying a control voltage to at least one of said elementary zones of said electrode.

In modification phase of the interconnections, the elementary zones of the counter-electrode, which are not in the connection reconfiguration zone, conserve a fixed potential. All of the elementary zones which must be reconfigured go to pulsation mode by applying the maximum authorised voltage. To apply a pulse, the elementary zones of the counter-electrode are brought to the maximum voltage that can be delivered by the active matrix of the counter-electrode and this in opposite phase of the elementary zones corresponding to the active matrix of the electrode. The principle of addressing to generate the voltage pulses is as follows. When an existing interconnection needs to the changed, all of the elementary zones are put to the same potential so as to erase the diffraction network of the preceding interconnection. The applying of a maximum voltage on all the elementary zones the old diffraction network to be erased quickly. This maximum voltage is created by moving the liquid crystal cell into alternate counter-electrode mode and by bringing the active matrices of the electrode and counter-electrode to their maximum voltages and in opposite phase. Finally, the voltages which correspond to the diffraction network of the new interconnection are applied to the active matrix of the electrode whilst the active matrix of the counter-electrode goes back to fixed mode.

In a particular manner, new voltage pulses can be applied via the active matrix of the electrode and via the active matrix of the counter-electrode in alternate counter-electrode mode, prior to the applying of the final voltages.

In a particular embodiment, an interconnection loading can comprise three phases: the erasing of the networks, the applying of an intermediary pulse, then the applying of the final voltages for the writing of the new networks.

In a particular embodiment of the method according to the invention, applied to the creating of a diffraction network so as to establish an optic interconnection between at least two fibres, this method comprises:
prior to said stage (c), a preliminary stage (b) of determining a region of at least one elementary zone of said counter-electrode onto which will be applied the voltage pulse;
upon the completion of stage (c), an intermediary stage (d) of applying the voltage pulse, in opposite phase, to the elementary zones of the electrode placed facing the predetermined elementary zones of the counter-electrode.

Preferably, the method according to the invention comprises a preliminary stage (a) of erasing the diffraction network of the preceding optic interconnection, by applying a same potential to all of the elementary zones of the electrode and counter-electrode, the stage (e) therefore corresponds to the establishing of a new diffraction network.

Preferably, the active matrix of the electrode is of liquid crystal type made on a substrate of silicon type (LCOS) and the active matrix of the counter-electrode is of transistor type (TFT) made on a glass substrate.

Advantageously, the method according to the invention comprises stages of:
preparing a plate of silicon substrate and a glass plate of at least the dimensions of said active matrices of said electrode and said counter-electrode, respectively;
etching of at least one elementary zone on said plates of substrate;
assembling in the substantially parallel planes of said plates of substrate of said electrode and counter-electrode, so that each of the elementary zones of the counter-electrode are substantially placed facing at least one elementary zone of said electrode;
injecting of said liquid crystal between the two plates of substrate so as to obtain a double active matrix device;
cutting out and transferring of said double active matrix device onto an electronic circuit.

In a particular embodiment of the invention, the transferring of the double active matrix device is carried out on an electronic circuit of Kapton type, and comprises stages of:
connection of the lines and columns of the active matrix of the counter-electrode to the Kapton circuit;
preparation of the electric conduction between the lines and columns of the counter-electrode with the Kapton circuit via the pressing of an adhesive containing conductive microbeads;
connection of the contact pads of the electrode on the Kapton circuit.

Preferably, the transferring stage of the double active matrix device on the electric circuit is made via anisotropic hot gluing.

Advantageously, the device according to the invention applies to the fields of visualisation applications of large alpha-graphic displays, to beam deflection, notably for optical commutation in open space or even to that of optic interconnection.

Other characteristics and advantages of the invention will become clearer upon reading the following description of a preferred embodiment, given by means of example and non restrictive, and of annexed diagrams, among which:

FIG. 1 shows a display unit with seven segments in transmissive mode, previously presented in this document;

FIG. 2 shows a crystal blazed grating known in the prior art;

FIG. 3 illustrates an active matrix of transistors known in the devices of the prior art;

FIG. 4 shows the electric diagram equivalent to an active matrix according to the prior art;

FIG. 5 shows a chronogram of the voltages of an active matrix according to the prior art;

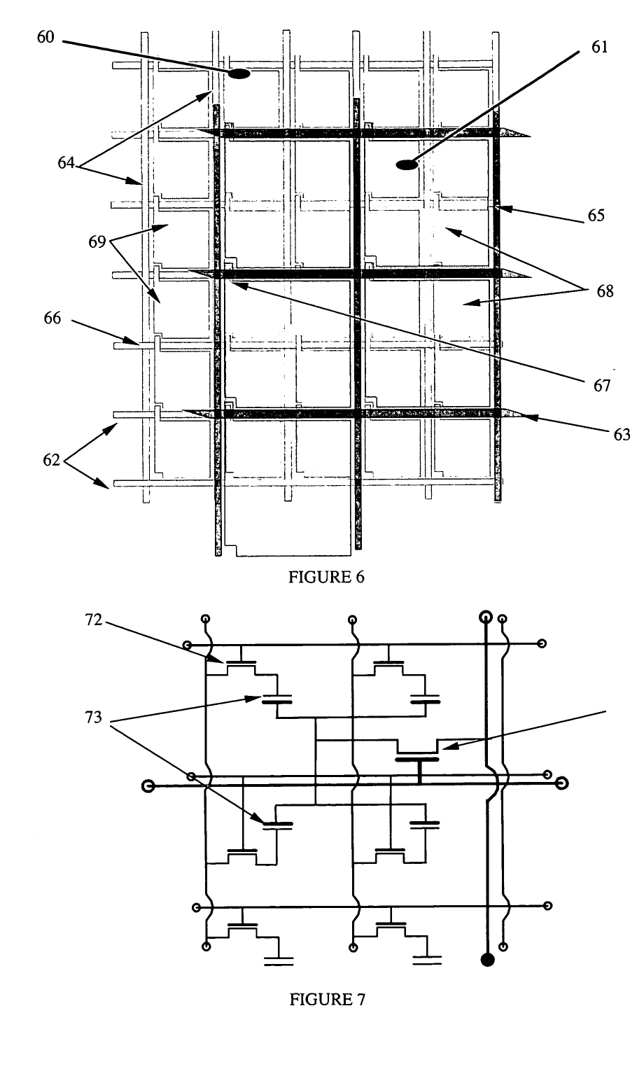

FIG. 6 illustrates a double active matrix liquid crystal cell used in the device according to the invention;

FIG. 7 shows the electric diagram equivalent to the double active matrix structure of FIG. 6;

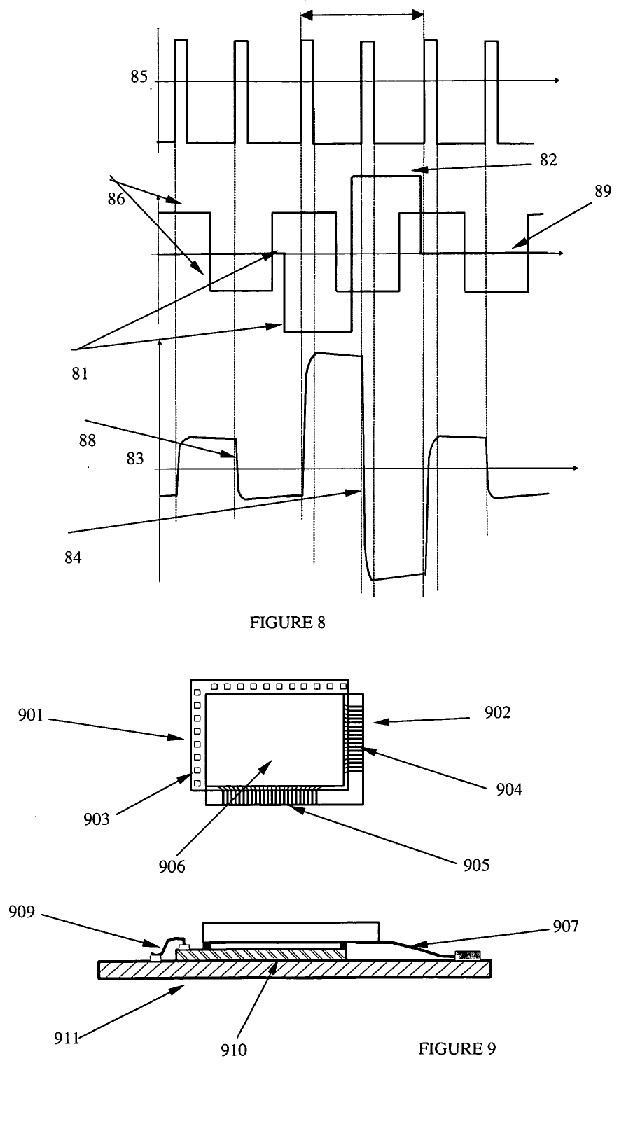

FIG. 8 shows the chronogram associated with a double active matrix structure used in the device according to the invention;

FIG. 9 illustrates the assembly of a particular double active matrix structure comprising an electrode of LCOS type and a counter-electrode of TFT type on a circuit of Kapton type.

In the example of FIG. 6 illustrating a liquid crystal cell according to the invention, a counter-electrode 61 is superimposed on a high-definition electrode 60. The electrode 60 and the counter-electrode 61 are both structured in the form of active matrices respectively bearing a set of lines 62 and 63, of columns 64 and 65, and a set of transistors 66 and 67. In this example, each pixel 68 of the counter-electrode covers four pixels 69 of the electrode.

FIG. 7 illustrates the electric diagram equivalent to the double active matrix structure in FIG. 6. In the shown configuration, each transistor 71 of the counter-electrode is linked through liquid crystal to each of the four transistors 72 of the electrode that are associated with it, the latter themselves being respectively linked to the capacities 73 of the elementary zones (or pixels) corresponding to the electrode.

FIG. 8 shows the chronogram of the voltages of a double active matrix device according to the invention.

In the case of a new interconnection between two optic fibres, the management electronics defines the zone of the active matrix of the counter-electrode which is concerned with the passing of the optic beam. This zone commutes in alternate mode with counter-electrode 81 and the system applies the maximum voltage that can be delivered 82 via the specific circuits, or drivers, linked to the columns. The pixels of the active matrix of the electrode corresponding to this interconnection are brought to a voltage 83 corresponding to the maximum voltage 84 that the active matrix of the electrode can deliver. This maximum voltage is delivered by the voltages of the lines 85 and of the columns 86 of the active matrix of the electrode and in opposite phase with regard to the voltages 81 delivered by the columns of the active matrix of the counter-electrode. The voltage pulse is applied for a duration 87 of 5 to 10 ms. Finally, the voltages 88 corresponding to the diffraction network are applied to the active matrix of the electrode whilst the active matrix of the counter-electrode goes back to the fixed counter-electrode mode 89. Two phases are therefore necessary to establish a new optic interconnection: the applying of a voltage pulse, and then the applying of final voltages.

In the case of loading an extant interconnection, all the pixels are put to the same potential so as to erase the diffraction network of the previous interconnection. The applying of a maximum voltage on all the pixels the old diffraction network to be erased quickly. This maximum voltage is created by passing the cell in alternate counter-electrode mode and by bringing the active matrices of the electrode and the counter-electrode to their maximum voltages and in opposite phase. Finally, the voltages corresponding to the diffraction network of the new interconnection are applied to the active matrix of the electrode whilst the active matrix of the counter-electrode goes back to the fixed counter-electrode mode. New voltage pulses may be applied via the active matrix of the electrode and the counter-electrode in alternate counter-electrode mode, before applying the final voltages.

An interconnection loading can thus comprise three phases: the erasing of the networks, the applying of an intermediate pulse, then the applying of the final voltages for the writing of new diffraction networks.

FIG. 9 illustrates a double active matrix device and its transferring method onto an electric circuit of Kapton type, according to the invention. The active matrix of the electrode 901 is made according to the LCOS technology and the active matrix of the electrode 902 is made according to the TFT technology on a glass substrate. The double active matrix liquid crystal cell, according to the invention, allows electric contact pads 903 to appear on two sides of the active matrix of the electrode as well as the line connections 904 and the column connections 905 of the active matrix of the counter-electrode. The liquid crystal 906 is confined between the plates of silicon substrate and glass of the active matrices of the counter-electrode 901 and the electrode 902.

In the particular case of the invention where we assemble an active matrix of the electrode of LCOS type and an active matrix of the counter-electrode in TFT on glass, the following technique is recommended. The active matrix LCOS is made on a silicon substrate according to semiconductor technology. The silicon wafers have a diameter of 150 mm to 300 mm. The transferring of this cell will be done in several stages.

Firstly, we connect the drivers 907 to the lines and columns of the counter-electrode on the two sides that were left accessible via the prior cutting out of the elementary zones of each active matrix in the substrate plates. These drivers 907 are generally fitted to specific flexible circuits. This transferring is carried out with the help of the known technique of anisotropic hot gluing. An adhesive 98 containing conductive microbeads is pressed between the counter-electrode and the drivers 907 which ensures an electric conduction between the lines of connection of the counter-electrode and those of the flexible circuit supporting the drivers while ensuring that there are no short circuits between two neighbouring paths. Then, we return the cell with its two flexible circuits and we carry out the transferring of the LCOS on a ceramic support 910 stuck to a flexible Kapton circuit 911 designed for this purpose. All that remains is then to carry out the connection by link 909 between the pads of the LCOS 903 and the Kapton circuit 911.

1. Liquid crystal device for the space modulation of light comprising at least one control electrode structured in the form of a first active matrix defining a plurality of first elementary zones, and at least one counter-electrode, characterised in that said counter-electrode is structured in the form of a second active matrix defining a plurality of second elementary zones.

2. Device according to claim 1, characterised in that it comprises first means of applying an electric voltage pulse to said electrode and/or said counter-electrode.

3. Device according to claim 2, characterised in that said means of applying a voltage pulse selectively apply said electric voltage pulse to a region defined by at least one of said elementary zones of said electrode and/or said counter-electrode.

4. Device according to claim 1, characterised in that it comprises means of selective addressing of at least some of said elementary zones of said electrode and of said counter-electrode.

5. Device according to claim 4, characterised in that said means of addressing are means of applying and of multiplexing control voltages, piloting said electrode and said counter-electrode.

6. Device according claim 1, characterised in that each of said elementary zones is associated with at least a control transistor.

7. Device according to claim 1, characterised in that said electrode and counter-electrode are assembled facing each other, in substantially parallel planes.

8. Device according to claim 1, characterised in that said liquid crystal is confined between said electrode and counter-electrode.

9. Device according to claim 8, characterised in that said liquid crystal belongs to the group comprising:
nematic type liquid crystals;
smectic type liquid crystals;
ferroelectric type liquid crystals;
cholesteric type liquid crystals.

10. Device according to claim 5, characterised in that the amplitude of said voltage pulse is substantially greater than the maximum voltage delivered by said means of selective addressing of said elementary zones of said electrode.

11. Device according to claim 1, characterised in that at least some of said second elementary zones have a surface and/or a shape different from said first elementary zones that are facing it.

12. Device according to claim 11, characterised in that at least some of said second elementary zones have a surface greater than or equal to that of said first elementary zones that are facing it.

13. Device according to claim 11, characterised in that at least one elementary zone of said counter-electrode is placed facing at least one elementary zone of said electrode.

14. Device according to claim 1, characterised in that said electrode and counter-electrode are made on at least one glass or silicon substrate plate.

15. Device according to claim 1, characterised in that said electrode and/or said counter-electrode have at least two orientation films of liquid crystal.

16. Method of liquid crystal space modulation of light comprising at least one control electrode structured in the form of a first active matrix comprising a plurality of elementary zones, and at least one counter-electrode, characterised in that a plurality of second elementary zones controlled by a second active matrix is defined on said counter-electrode.

17. Method according to claim 16, characterised in that it comprises the successive stages of:
(c) applying a voltage pulse to at least one of said elementary zones of said counter-electrode;
(e) applying a control voltage to at least one of said elementary zones of said electrode.

18. Method of liquid crystal space modulation of light according to claim 17, characterised in that it is applied to the creation of a diffraction network so as to establish an optic interconnection between at least two fibres and in that it comprises:
prior to said stage (c), a preliminary stage (b) of determining a region of at least one elementary zone of said counter-electrode onto which will be applied said voltage pulse;
upon the completion of stage (c), an intermediary stage (d) of applying said voltage pulse, in opposite phase, to said elementary zones of the electrode placed facing said predetermined elementary zones of the counter-electrode.

19. Method of liquid crystal space modulation of light according to claim 18, characterised in that it comprises a preliminary stage (a) of erasing the diffraction network of the preceding optic interconnection, by applying a same potential to all of the elementary zones of said electrode and counter-electrode, the stage (e) therefore corresponding to the establishing of a new diffraction network.

20. Method of making a device for the space modulation of light according to claim 1, characterised in that said active matrix of said electrode is of liquid crystal type made on a substrate of silicon type (LCOS) and said active matrix of said counter-electrode is of transistor type (TFT) made on a glass substrate.

21. Method according to claim 20, characterised in that it comprises the stages of:
preparing a plate of silicon substrate and a glass plate of at least the dimensions of said active matrices of said electrode and said counter-electrode, respectively;
etching of at least one elementary zone on said plates of substrate;
assembling in the substantially parallel planes of said plates of substrate of said electrode and counter-electrode, so that each of the elementary zones of the counter-electrode are substantially placed facing at least one elementary zone of said electrode;
injecting of said liquid crystal between the two plates of substrate so as to obtain a double active matrix device;
cutting out and transferring of said double active matrix device onto an electronic circuit.

22. Method according to claim 21, characterised in that the transferring of said double active matrix device is carried out on an electronic circuit of Kapton type and in that it comprises stages of:
connection of the lines and columns of the active matrix of said counter-electrode to said Kapton circuit;
preparation of the electric conduction between said lines and columns of said counter-electrode with said Kapton circuit via the pressing of an adhesive containing conductive microbeads;
connection of the contact pads of said electrode on said Kapton circuit.

23. Method according to claim 22, characterised in that said transferring stage of said double active matrix device on said electric circuit is made via anisotropic hot gluing.

24. Application of the device according to claim 1, to the fields belonging to the group comprising:
visualisation applications of large alpha-graphic displays;
beam deflexion for optical fibre communication in open space;
optic interconnection.
